(19) United States
(12) Patent Application Publication
(10) Pub. No.: US 2007/0071903 A1
(43) Pub. Date: Mar. 29, 2007

(54) METHOD FOR MIXING AND APPLYING A MULTI-COMPONENT COATING COMPOSITION

(76) Inventors: James A. Claar, Apollo, PA (US); David N. Walters, Slippery Rock, PA (US); Truman F. Wilt, Clinton, PA (US); John R. Rassau, Allison Park, PA (US)

Correspondence Address: PPG INDUSTRIES, INC.;Intellectual Property Dept., One PPG Place, Pittsburgh, PA, 15272, US

(21) Appl. No.: 11/561,457

(22) Filed: Nov. 20, 2006

Related U.S. Application Data
(63) Continuation-in-part of application No. 10/324,725, filed on Dec. 19, 2002.
(60) Provisional application No. 60/343,076, filed on Dec. 20, 2001.

(51) Int. Cl. B05D 7/00

(52) U.S. Cl. 427/421.1

(57) ABSTRACT

A method of applying a multi-component coating composition to a substrate is disclosed. The coating composition comprises a polymeric component containing reactive functional groups and a hardener component comprising a curing agent having coreactive functional groups. The composition is applied with a spray applicator and the rheological profile of the polymeric component is adjusted by adding to the polymeric component one or more materials having a lower molecular weight than the polymeric component and which contain functional groups reactive with the curing agent such that the polymeric component and the hardener component are delivered to a mixing chamber in the spray gun at a predetermined volume ratio over a varied range of temperatures and shear rates.

### CROSS REFERENCE TO RELATED APPLICATION

This application is a continuation-in-part of application Ser. No. 10/324,725, filed Dec. 19, 2002, which claims the benefit of provisional application Ser. No. 60/343,076, filed Dec. 20, 2001, and application Ser. No. 10/870,301, filed Jun. 17, 2004.

### BACKGROUND OF THE INVENTION

1. Field of the Invention

This application relates generally to a method and apparatus for applying a multi-component coating of a desired composition over a substrate and, more particularly, to a method and apparatus for applying a multi-component refinish coating over an automotive substrate.

2. Technical Considerations

Automotive refinish coatings are used to cover damaged areas of a vehicle in order to restore the original appearance of the vehicle. Conventional refinish coatings are typically supplied to automotive repair shops in the form of multi-package systems. An example of one such system is a two-package system, with one package containing a polymeric material and the other package containing a catalyst or curing agent. When a refinish coating is to be applied onto an automotive substrate, the components in the separate packages are mixed together; typically at a particular ratio specified by the coating manufacturer, and the mixed coating composition is placed into a container. The container is connected to a coating device, such as a pneumatic spray gun, and the mixed coating composition is spray applied onto the automotive substrate.

While generally acceptable for most automotive refinish operations, this conventional refinish coating method does have some drawbacks. For instance, after mixing the separate components together, the pot-life of the resultant coating composition is typically limited to only about 30 minutes. By “pot-life” is meant the time within which the coating composition must be used before the coating composition becomes too viscous to be applied due to cross-linking or curing. Also, since most refinish coating jobs need only cover a relatively small area of a vehicle, the separate packages typically do not contain a large amount of the respective coating components. Therefore, for larger jobs, several different batches of the coating composition must be consecutively prepared and applied. This batch mixing increases the time required to coat a large substrate and requires the coating process to be intermittently stopped and started while batches of the coating composition are mixed. As will be appreciated by one skilled in the refinish coating art, it would be advantageous to increase the curing speed of the coating composition to decrease the curing time of the applied coating composition so that the applied coating could be more quickly sanded or further coatings applied. However, increasing the curing speed would also disadvantageously decrease the pot-life of the mixed coating composition.

In an attempt to alleviate some of these problems, spray devices have been developed in which specific amounts of the separate coating components are mechanically metered to the spray device to provide a desired coating composition. Examples of known coating dispensers are disclosed in U.S. Pat. Nos. 5,405,083; 4,881,821; 4,767,025; and 6,131,823. While generally acceptable, the mechanical pumping and metering equipment required to accurately meter specific amounts of the coating components to the spray device add to the overall cost of the system. Moreover, the metering equipment must be regularly checked and maintained to ensure that it is in proper working order to accurately supply the required amounts of the coating components to the spray device.

As will be appreciated by one skilled in the automotive refinish coating art, it would be advantageous to provide a method and/or apparatus for applying a multi-component coating onto a substrate which reduces or eliminates at least some of the drawbacks of known coating application systems.

### SUMMARY OF THE INVENTION

A method of applying a multi-component coating composition to a substrate is provided. The coating composition comprises:
(1) a polymeric component having reactive functional groups and
(2) a hardener component comprising a curing agent for the polymeric component; the curing agent having functional groups reactive with the functional groups of the polymeric component.

The coating composition is applied with a spray applicator in which each component is delivered to and mixed in a mixing chamber within the spray applicator to form a coating mixture that is discharged from the spray applicator to form a coating on the substrate. The method further comprises:

adjusting the rheological profile of the polymeric component by adding one or more lower molecular weight materials to the polymeric component, which contain functional groups reactive with the functional groups of the curing agent such that the polymeric component and the hardener component are delivered to the spray applicator at a predetermined volume ratio over a varied temperature range and shear rate range.

The method enables the application of coating compositions of low organic volatile contents, typically less than ten (10) percent by weight based on total weight of the coating mixture.

### BRIEF DESCRIPTION OF THE DRAWINGS

FIG. 1 is a schematic, side view (not to scale) of a coating system incorporating features of the invention;

FIG. 2 shows graphical plots of viscosity as a function of temperature and of shear rate for various coating compositions.

### DESCRIPTION OF THE INVENTION

As used herein, spatial or directional terms, such as “left”, “right”, “inner”, “outer”, “above”, “below”, “top”, “bottom”, and the like, relate to the invention as it is shown in the drawing figures. However, it is to be understood that the invention may assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to include the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. Further, as used herein, terms such as “deposited over”, “applied over”, or “provided over” mean deposited or provided on but not necessarily in contact with the surface. For example, a coating composition “deposited over” a substrate does not preclude the presence of one or more other coating films of the same or different composition located between the deposited coating and the substrate. Molecular weight quantities used herein, whether Mn or Mw, are those determinable from gel permeation chromatography using polystyrene as a standard. Also, as used herein, the term “polymer” includes oligomers, homopolymers, and copolymers.

Exemplary apparatus and methods for applying a multi-component coating onto a substrate in accordance with the present invention will now be described with particular reference to the application of a multi-component, e.g., two component, refinish coating onto an automotive substrate using a pneumatic spray device. However, it is to be understood that the invention is not limited to use with refinish coatings or automotive substrates but can be practiced with any multi-component coating type on any desired substrate. Additionally, the invention is not limited to use with pneumatic spray devices. Moreover, the invention is not limited to two component systems but can be practiced with any number of components, e.g., two or more components.

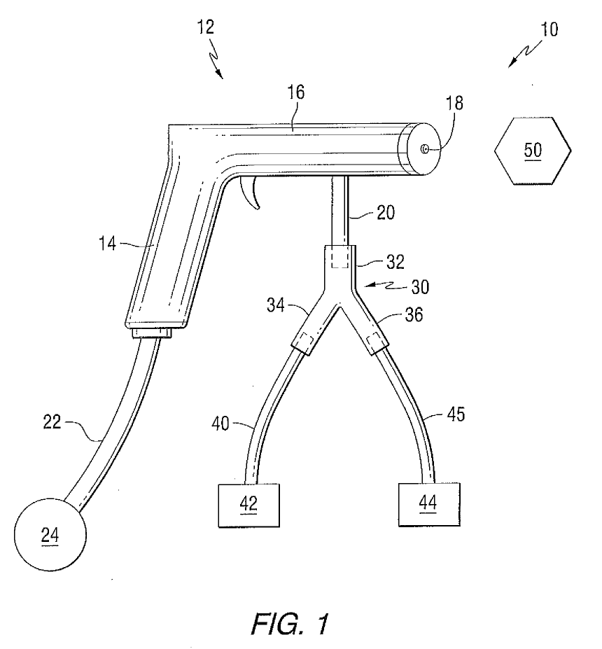

A first exemplary coating system 10 incorporating features of the invention is schematically shown in FIG. 1. The system 10 includes a spray applicator 12. The spray applicator 12 can be of any conventional type, such as pneumatic, electrostatic, gravity fed, pressure fed, etc. In the exemplary embodiment shown in FIG. 1, the spray applicator 12 is a pneumatic, siphon-feed coating gun having a handle 14, a body 16, a nozzle 18, and a siphon tube 20. The spray applicator 12 also includes a carrier fluid conduit 22 in flow communication with a source 24 of carrier fluid, such as a liquid or gaseous carrier fluid. In one embodiment, the carrier fluid is compressed air supplied at a pressure of about 10 pounds per square inch-gauge (psig) to 100 psig (0.7 kg/sq. cm to 7 kg/sq. cm), such as 20 psig to 80 psig (1.4 kg/sq. cm to 5.6 kg/sq. cm), e.g., 40 psig to 60 psig (2.8 kg/sq. cm to 4.2 kg/sq. cm). As will be appreciated by one skilled in the art, the carrier fluid conduit 22 directs carrier fluid through a passage in the spray applicator 12 to the nozzle 18. The inner end of the siphon tube 20 is in flow communication with the carrier fluid passage in the spray applicator 12 in conventional manner. The structure and operation of a conventional pneumatic, siphon-feed spray gun will be well understood by one of ordinary skill in the automotive refinish art and, hence, will not be discussed in detail. One suitable pneumatic, siphon-feed spray applicator that can be used in the practice of the invention is a Binks Model 62 spray gun manufactured by ITW Incorporated.

In previous practice, the siphon tube 20 would be connected to a single container containing a mixed coating composition as described above. However, in the practice of the invention, the siphon tube 20 is connected to, or forms, a multi-inlet connector 30. In the embodiment shown in FIG. 17 the connector 30 is depicted as a hollow, “Y-shaped” connector having a base 32, a first inlet or conduit 34 and a second inlet or conduit 36. The base 32 is connected to the siphon tube 20, e.g., by a friction fit or by any conventional attachment devices. The first conduit 34 is connected to a first conduit or collection tube 40 in flow communication with a source 42 of a first coating component, e.g., one component of a multi-component refinish coating, and the second conduit 36 is connected to a second conduit or collection tube 45 in flow communication with a source 44 of a second coating component, e.g., another component of the multi-component refinish coating. While in this exemplary embodiment only two conduits 34, 36 are present on the connector 30, it will be appreciated by one of ordinary skill in the art that the invention is not limited to use with two-component systems. For example, for three-component systems, the connector 30 could have three inlets (conduits), each in flow communication with one of the coating components. Additionally, the collection tubes 40, 45 do not have to be separate pieces but could simply be extensions of the first and second conduits 34, 36.

For purposes of explanation with respect to a two-component system, the first component can be a liquid solution or dispersion of polymer having at least two reactive functional groups, for example, hydroxyl, epoxy, acid, amine, or acetoacetate groups. The polymer can be, for example, a polyester, polyurethane, polysiloxane, or an acrylic including methacrylic copolymer referred to as a (meth)acrylic copolymer. In one embodiment, the first component can include a polymeric polyol, e.g., a polyester polyol or a (meth)acrylic copolymer having an Mn in the range of 200 to 100,000, such as 1,000 to 75,000, such as 3,000 to 50,000, such as 5,000 to 20,000.

The second component or hardener component can be a crosslinking agent in liquid form, e.g., a solution, and can include one or more materials having functional groups reactive with the functional groups of the polymeric component to cure or crosslink with the polymeric component to form the resultant coating. For example, but not to be considered as limiting, the second component can include a polyisocyanate curing agent, aminoplast resins, or phenoplast resins. Examples of suitable coating components and curing agents for the practice of the invention are disclosed in, but are not limited to, U.S. Pat. Nos. 6,297,311; 6,136,928; 5,869,566; 6,054,535; 6,228,971; 6,130,286; 6,169,150; and 6,005,045.

Unlike previous refinish coating systems, the system 10 of the present invention does not require the presence of supply pumps or metering pumps between the coating component sources 42 and 44 and the spray applicator 12 to meter selected amounts of the two components to the spray applicator 12. Rather, in the practice of the invention and as described below, the composition of the resultant coating composition applied onto a substrate 50 from the spray applicator 12 is adjusted by adjusting the rheological profile of the polymeric component and optionally the Theological profile of the hardener component. As used herein, the term “rheological profile” refers to the viscosity of a material as measured over a range of shear rates and temperature ranges.

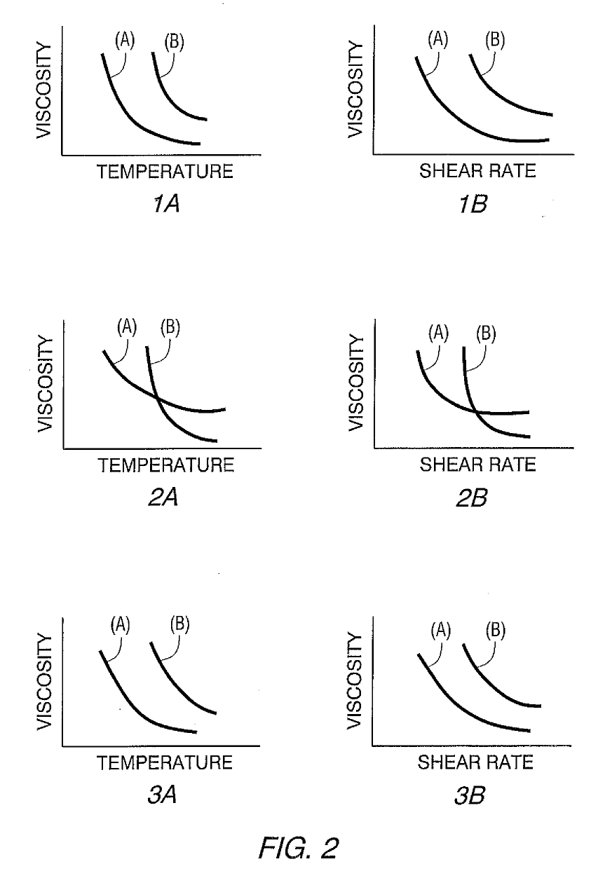

To help understand the importance of the rheological profile, reference is made to the attached FIG. 2 that are graphical plots showing viscosity as a function of temperature and shear rate for various coating compositions. In the plots, (A) represents the polymeric component and (B) the hardener component. 1A and 1B show that the change in viscosity with the change in temperature and shear rate for the two components (A) and (B) of a coating composition is the same for both components. Therefore, at any temperature and shear rate, the components (A) and (B) will be delivered to the mixing chamber at a known and constant volume ratio. This ratio will stay the same as the temperature and shear rate changes. However, most coating compositions are not this ideal. A more typical multi-component coating composition would be that shown in 2A and 2B. In these systems, the change in viscosity with the change in temperature and shear rate for the two components is different. Therefore, at varying ranges of temperature and shear rate, the components will not be delivered to the mixing chamber in the desired volume ratio. This may be significant because the temperature and shear rate are quite variable depending on location, time of the year and spray equipment used. However, if the rheological profile of the components (A) and/or (B) are adjusted to a situation such as shown in 3A and 3B, each component (A) and (B) will be delivered to the mixing chamber at the desired volume ratio over varied ranges of temperatures and shear rates.

Typically, the rheological profile of the hardener component is first determined. This can be done empirically by measuring the change in viscosity over a range of temperatures and shear rates. The rheological profile of the polymeric component is then determined empirically over the same range of temperatures and shear rates. The rheological profile of the polymeric component is then adjusted to match that of the hardener component. Optionally, the rheological profile of both the polymeric component and the hardener component are adjusted to match their respective rheological profiles.

Adjustment of the rheological profile of the polymeric component is accomplished by adding one or more lower molecular weight materials that contain functional groups reactive with the functional groups of the curing agent. The lower molecular weight materials have a lower molecular weight than the polymeric component and typically have molecular weights of 150 to 1000 on a number average basis. Preferably the curing agent is a polyisocyanate or a polyanhydride and the reactive functional groups of both the polymeric component and the lower molecular weight material are active hydrogens such as hydroxyl.

With reference to the two-component system described above, to apply a coating composition having two parts (e.g., two parts by volume) of the polymeric component, for example, an acrylic polyol having a number average molecular weight of about 10,000, and one part (e.g., one part by volume) of the hardener component, for example, a polyisocyanate comprising the isocyanate of 1,6-hexamethylene diisocyanate available from Bayer as DESMODUR N3300, the Theological profile of the polymeric component is adjusted by adding a mixture of hexane diol and trimethylolpropane (50/50 weight ratio) such that under the selected coating conditions (e.g., the applied shear rates and temperatures), the curing agent component has a viscosity two times the viscosity of the polymeric component. As the carrier fluid (e.g., compressed air) moves through the spray applicator 12, the suction created by the air flow sucks the polymeric and curing agent components through the collection tubes 40, 45, the connector 30, and into the spray applicator 12 where the two components are mixed in conventional manner, such as by flow through a mixing chamber, before being discharged through the nozzle 18.

The following Examples are presented to demonstrate the general principles of the invention. However, the invention should not be considered as limited to the specific Examples presented.

### EXAMPLE 1

A multi-component coating composition comprising a polymeric component having reactive hydroxyl groups and a hardener component comprising a curing agent for the polymeric component were prepared from the following ingredients:

| | Weight in | |
|---|---|---|
| | grams | Solid Resin |
| Polymeric Component | | |
| Methyl isobutyl ketone | 30.54 | |
| Pentyl propionate | 46.33 | |
| Methyl isoamyl ketone | 49.30 | |
| UV absorber¹ | 4.58 | 4.58 |
| Light stabilizer² | 4.05 | 4.05 |
| Flow additive³ | 1.71 | 0.86 |
| Dibutyltin dilaurate | 3.02 | 3.02 |
| Isostearic acid | 2.98 | 2.98 |
| Reactive diluent⁴ | 24.28 | 24.28 |
| Acrylic polyol⁵ | 106.30 | 60.06 |
| Acrylic polyol 2⁶ | 113.98 | 72.95 |
| Sub Total | 387.07 | 172.78 |
| Curing Agent Component | | |
| Methyl isobutyl ketone | 18.29 | |
| Pentyl propionate | 27.74 | |
| Methyl isoamyl ketone | 29.52 | |
| Flow additive³ | 1.72 | 0.86 |
| Isocyanate 1⁷ | 61.02 | 61.02 |
| Isocyanate 2⁸ | 173.33 | 121.33 |
| Rheology modifier⁹ | 103.83 | 41.53 |
| Total | 802.53 | 397.53 |

¹Available from Ciba Geigy Corp as Tinuvin 328.
²Available from Ciba Geigy Corp. as Tinuvin 292.
³Available from Byk-Chemie Corp. as Byk 300.
⁴Available from Perstorp as Propoxylated Trimethylol Propane, TP-30.
⁵Acrylic polyol solution in xylene prepared from (on a weight basis): 23.2% hydroxypropyl acrylate, 10.7% methyl methacrylate, 32.4% styrene, 11.2% glycidyl methacrylate and 22.4% isostearic acid.
⁶Acrylic polyol solution in xylene prepared from 5% acrylic acid monomer, 20.5% butyl methacrylate, 25.1% methyl methacrylate, 18.1% styrene, 28.9% hydroxypropyl methacrylate and 1.5% acrylic acid.
⁷Hexamethylene Diisocyanate Polymer available from Bayer Corp as Des N 3600.
⁸Isophorone diisocyanate trimer available from Bayer Corp. as Des N 4470.
⁹Acrylic resin solution in 50/50 (by weight) toluene/methyl isobutyl ketone prepared from (on a weight basis) 90% methyl methacrylate and 10% butyl methacrylate.

The two coating components were prepared by blending the ingredients under mild mechanical agitation. For spraying, a Binks Model 62 siphon-feed spray gun (manufactured by ITW Incorporated) was modified by attaching a piece of Tygo tube 2 inches (5 cm) long having an inner diameter of ⅜ inch (0.95 cm) to the spray gun siphon tube. A plastic “Y” connector 2 inches (5 cm) long and having an inner diameter of ¼ inch (0.6 cm) was connected to the other end of the Tygo tube. A piece of Tygo tube having a length of 3 inches (7.6 cm) and an inner diameter of ⅜ inch (0.95 cm) was attached to each branch of the Y connector to provide two collection tubes extending from the connector. Volume mix ratio of these components through the spray equipment at room temperature was measured at 1.05:1.00. Viscosity measurements were then obtained using a Brookfield LVT viscometer with a number 1 spindle and 60 rpm for each component at a variety of temperatures. As seen in the following Table, the viscosity of the two components is observed to change with changes in temperature. Higher temperature reduces the viscosity while lower temperature increases viscosity. However, the two components experience the same change in viscosity relative to temperature and thus the volume mix ratio through the spray equipment remains constant regardless of ambient temperature.

| Temperature | | |
|---|---|---|
| (° F.) | Hardener | Clear |
| 40 | 54.5 | 53 |
| 50 | 39.5 | 37.5 |
| 60 | 33 | 31 |
| 70 | 28 | 26.5 |
| 80 | 21.5 | 20 |
| 90 | 18 | 17.5 |

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method of applying a multi-component coating composition comprising (1) a polymeric component having reactive functional groups and (2) a hardener component comprising a curing agent for the polymeric component; the curing agent having functional groups reactive with the functional groups of the polymeric component, to a substrate with a spray applicator in which each component is delivered to and mixed in a mixing chamber within the spray applicator to form a coating mixture that is discharged from the spray applicator to form a coating on the substrate; the method further comprising:
adjusting the rheological profile of the polymeric component by adding to the polymeric component one or more materials having a lower molecular weight than the polymeric component, and which contain functional groups reactive with the functional groups of the curing agent such that the polymeric component and the hardener component are delivered to the spray applicator at a predetermined volume ratio over a varied temperature range and shear rate range.

2. The method of claim 1 in which the rheological profile of both the polymeric component and the hardener component are adjusted.

3. The method of claim 1 in which the coating mixture has a volatile content of less than 10 percent by weight based on total weight of the coating mixture.

4. The method of claim 1 in which the reactive functional groups of the polymeric component are active hydrogen groups.

5. The method of claim 4 in which the active hydrogens are selected from hydroxyl and amine.

6. The method of claim 5 in which the curing agent is selected from polyisocyanates and polyanhydrides.

7. The method of claim 6 in which the curing agent is a polyisocyanate.

8. The method of claim 4 in which the reactive functional groups of the polymeric component are active hydrogens and the lower molecular weight material contains active hydrogens.

9. The method of claim 8 in which the active hydrogens are hydroxyl.

10. The method of claim 9 in which the curing agent is a polyisocyanate.

11. A method of applying a multi-component coating composition to a substrate, comprising (1) a polymeric component having reactive functional groups and (2) a hardener component comprising a curing agent having functional groups reactive with the functional group of the polymeric component, to a substrate with a spray applicator in which each component is delivered to and mixed in a mixing chamber within the spray applicator to form a coating mixture that is discharged from the spray applicator to form a coating on the substrate; the method further comprising:
(a) adjusting the rheological profile of the hardener component;
(b) adjusting the rheological profile of the polymeric component by the inclusion of one or more materials having a lower molecular weight than the polymeric component and which contain functional groups reactive with the functional group of the polymeric component such that each of the polymeric component and hardener component are delivered to the spray applicator at a predetermined volume ratio over a varied temperature range and shear rate range.

12. The method of claim 11 in which the coating mixture has a volatile content less than 10 percent by weight based on total weight of the coating composition.
